(19) United States
(12) Patent Application Publication
(10) Pub. No.: US 2022/0085701 A1
(43) Pub. Date: Mar. 17, 2022

(54) AXIAL FLUX MACHINE AND METHOD FOR THE MANUFACTURING THEREOF

(71) Applicant: JOVAL NV, Kortrijk (BE)

(72) Inventor: Jozef Robrecht Jan VERSAVEL, Kortrijk (BE)

(21) Appl. No.: 17/416,940

(22) PCT Filed: Dec. 10, 2019
(86) PCT No.: PCT/EP2019/084407

§ 371 Date: Jun. 21, 2021

(30) Foreign Application Priority Data
Dec. 24, 2018 (BE) BE2018/5945

(51) Int. Cl. H02K 15/00; H02K 5/173; H02K 7/08; H02K 7/18; H02K 21/24; F03D 80/70

(52) U.S. Cl. CPC H02K 15/00; H02K 5/1737; H02K 7/086; H02K 7/183; F05B 2240/10; F03D 80/70; F05B 2240/60; F05B 2240/50; H02K 21/24

(57) ABSTRACT

A method for manufacturing an axial flux machine adapted for generating a magnetic flux along the axis of rotation, includes the manufacturing of one or more stators, having the following steps: providing a surface comprising one or more flat support surfaces perpendicular to the axis of rotation; positioning one or more boundary elements, individual stator elements, and a ring element on the one or more support surfaces. At least one of the boundary elements is a cooling element adapted for conducting heat. The stator elements each has a ferromagnetic core and an electric winding wound around the ferromagnetic core, and filling the empty space between the outer circumference, the stator elements and the ring element with an electrically insulating filling material.

### TECHNICAL DOMAIN

The present invention generally relates to an axial flux machine and a method for its manufacturing. The invention in particular provides a method enabling the manufacturing of a high-yield machine that is lightweight yet robust, and which can be made in an efficient manner.

### BACKGROUND OF THE INVENTION

Within the range of electrical machines, for instance generators and motors, axial flux machines are a type with promising characteristics. Axial flux machines use a fundamentally different configuration than the more classic radial flux machines. Whereas in a radial flux machine the flux is generated in radial direction, in an axial flux machine this takes place in axial direction, that means along the direction of the axis of rotation. Typically, use is then made of permanent magnets that are arranged on two parallel rotor disks. The permanent magnets have been magnetized in axial direction, and the rotor disks are perpendicular to the axis of rotation. A stator disk is situated between both parallel rotor disks, with a narrow air gap between the stator disk and the respective rotor disks. In a topology without a stator yoke, the magnetic flux of a magnet on the one rotor disk runs through a stator core to a corresponding magnet on the other rotor disk. Windings, for instance of copper wire, are each time arranged around the stator cores. During operation of the generator, the rotation of the rotors ensures an alternating magnetic flux, which induces an electric current in the windings. Apart from a configuration having one stator and two rotors, other topologies having different numbers of stators and/or rotors are also possible.

Such an axial flux configuration provides the potential for an electrical machine that is compact, having a short axial length, lightweight and efficient. In particular for the application as a generator in a wind turbine, this machine provides a promising alternative to other types of electrical generators. However, when scaling up an axial flux machine to such Megawatt applications, manufacturers are faced with a number of problems.

Achieving optimal efficiency first of all requires a very narrow air gap (in the order of 1 mm) between the stator disk and the respective rotor disks. On the other hand, it has to be prevented at all times that a rotor disk and stator disk get into contact with each other during operation. However, in a wind turbine application in which a large capacity needs to be generated and the rotor disks, stator disks and stators consequently have a large circumference, in the order of 1.5 m, guaranteeing the required accuracy of the narrow air gap at all locations during the production of the rotor and stator is not self-evident. In addition, such a high capacity application requires sufficient cooling, which preferably is realized without having to bring a fluid coolant close to the stator coils.

Furthermore, for a wind turbine application the generator needs to be mounted at altitude. In case of generators of large weight, this requires special facilities, for instance a heavy crane. This entails large costs and certain conditions, such as much wind, will make the use of such facilities more difficult. A large weight of the generator also makes the (attachment to the) wind turbine base more complex and/or heavier. As a consequence, how to make the stator(s) and rotor(s) as lightweight as possible despite their large dimensions, proves to be a problem. In addition, the full weight of the assembly to be mounted, which is also determined by the weight of for instance vanes and a turbine housing, needs to be limited as much as possible.

During the operation of a wind turbine generator, enormous mechanical forces also occur as a result of the high capacities and large peripheral velocities. As a consequence, manufacturers are faced with the problem of how the various stator parts and rotor parts can be sufficiently firmly anchored so as to obtain a robust and durable machine.

To conclude with, the cost price of the wind turbine generator forms an essential aspect. The costs of manufacturing the generator constitute an important part thereof. As a consequence, manufacturers are faced with the problem of how the generator can efficiently be made despite the above demands made on the design. This requires an easy production of parts as well as an uncomplicated assembling.

As a consequence, there is a general need of an axial flux machine that is suitable for a wind turbine generator application, and that can be made in an efficient manner.

Solutions for axial flux machines are known that enhance the efficiency and durability of the machine by using internal cooling fins in the design. In WO2018/015293 for instance a stator is described in which use is made of an annular circumference with cooling fins extending between the stator teeth. This makes it possible to obtain a proper heat discharge even in a highly compact embodiment of the machine. Laminating the cooling fins and the housing moreover prevents eddy currents, which is also beneficial to the efficiency. The stator teeth, however, need to be placed very accurately within the cavities formed by the cooling fins. This makes the assembling more difficult and there is a risk of damaging the (insulating) exterior surface of the stator teeth. The production of the annular circumference, of which the cooling fins preferably form an integral part, is not easy to execute either. Particularly when it regards a large circumference, an expensive production technique is required. To conclude with, the method and the design of WO2018/015293 do not in any way guarantee the accurate thickness of the narrow air gap, which may cause problems with stators and rotors of large dimensions.

Solutions are also known for axial flux machines that pursue an improvement of the ease of assembling. In US2006/0043821 for instance, use is made of stator teeth comprising the coils and having two flanges. Due to the specific configuration of the flanges, the stator teeth can be positioned and secured easily. The specific configuration, however, renders the production of these parts difficult, and positioning requires extra parts, such as plates or a ring having apertures attaching the stator teeth to each other. Moreover, no internal cooling fins between the stator teeth are provided in this solution. This facilitates the assembling but results in a less efficient cooling.

Solutions are also known in which the assembly that has to be mounted at the top of the wind turbine base, is reduced in terms of weight. In WO2014/187933 for instance, a system including tension cables is described enabling the vanes to be executed more lightweight and less complex. However, there still is a turbine housing causing extra weight, and no solution is described for limiting the weight of rotor and stator.

It is an object of the present invention to describe an axial flux machine and a method for manufacturing an axial flux machine, overcoming the drawbacks of the solutions according to the state of the art as described above. More specifically, it is an object of the present invention to describe a method for manufacturing an axial flux machine enabling the manufacturing of a high-yield machine that is lightweight yet robust, and which can be made in an efficient manner.

### SUMMARY OF THE INVENTION

According to a first aspect of the invention, a method is provided for manufacturing an axial flux machine adapted for generating a magnetic flux along the axis of rotation, wherein this method comprises manufacturing one or more stators, and wherein the manufacturing of a stator comprises the following steps:
providing a surface comprising one or more flat support surfaces perpendicular to the axis of rotation;
positioning a ring element on the one or more support surfaces;
positioning one or more boundary elements, individual stator elements, and a ring element on the one or more support surfaces, wherein at least one of the boundary elements is a cooling element adapted for conducting heat; wherein the stator elements each comprise a ferromagnetic core and an electric winding wound around this ferromagnetic core; and wherein after positioning, the one or more boundary elements together form an outer circumference, the individual stator elements and the ring element are situated within said outer circumference, and said individual stator elements are positioned around the ring element;
filling the empty space between the outer circumference, the stator elements and the ring element with an electrically insulating filling material.

In other words: the invention relates to a method for manufacturing an axial flux machine, particularly an electrical machine in which a magnetic flux is generated along the axis of rotation. When the machine is operational, the axis of rotation is the axis around which the one or more rotors rotate. The axis of rotation defines the axial direction. In an axial flux machine having two rotors and one stator, the magnetic flux lines run along an axial direction from the one rotor, through the stator, to the other rotor. The term axis of rotation is used here to indicate a reference direction against which the parts are oriented or dimensions are determined, even though it does not regard an operational generator with rotating rotor(s).

The method for manufacturing an axial flux machine comprises the manufacturing of one or more stators. The manufacturing of a stator comprises various steps. In the first step a surface is provided comprising one or more flat support surfaces that are perpendicular to the axis of rotation. The support surfaces are parts of the surface on which, in the method, various stator parts, such as a ring element, individual stator elements and one or more boundary elements are placed. It is important that such support surfaces are perfectly flat. The surface is for instance an entirely flat, perfectly even table, that means the support surfaces are all in the same plane, and positioning the various stator parts for instance takes place by means of a position jig. Or the surface for instance is a flat table in which a number of recesses of perfectly even surface have been arranged which serve as support surfaces and permit an accurate positioning of the various stator parts. In the method, by providing flat support surfaces perpendicular to the axis of rotation, perfect control is obtained over how the stator parts positioned on the support surfaces will orient themselves relative to the axis of rotation after manufacturing the stator. In particular, this will permit obtaining a stator after manufacturing in which the ring element, the individual stator elements and the one or more boundary elements have surfaces that are perpendicular to the axis of rotation. This contributes to guaranteeing a constant air gap between stator and rotor, along the entire surface area of the stator disk. When assembling the stator and rotor, this permits the realization of a very narrow air gap, without the risk of contact between the stator disk and rotor disk. A narrow air gap contributes to a high-efficiency generator. Moreover, positioning stator parts on flat support surfaces provides a simple method for manufacturing the stator, which contributes to an efficient production of the generator.

Another step in the method according to the invention comprises positioning a ring element on the one or more support surfaces. The ring element is a part having a closed circumference, for instance a metal ring having a specific height or a ring of a radial bearing. Typically, the stator is a disk having a circular recess for the shaft of the machine in its center. The stator disk therefore has an inner circumference, namely the circumference of the circular recess, and an outer circumference. The ring element is intended for, after manufacturing the stator, forming the inner circumference of the stator disk. The height of the ring element, measured along the axis of rotation, will also determine the thickness of the stator disk, measured along the axis of rotation.

Another step in the method according to the invention comprises the positioning of individual stator elements. Each stator element comprises a ferromagnetic core and an electric winding wound around said ferromagnetic core. When the generator is operational, an electric current is induced in said windings. The individual stator elements are separate parts that stand apart from each other. Each of the stator elements is placed on a support surface. After positioning, the stator elements are situated around the ring element, typically evenly distributed along the circumference. By according to the method positioning the individual stator elements on the support surfaces perpendicular to the axis of rotation, a stator is obtained after manufacturing in which the cores including coil have a surface that is perpendicular to the axis of rotation. This contributes to guaranteeing a constant (narrow) air gap between the stator and rotor.

The one or more boundary elements are also positioned on support surfaces, and after positioning are situated around the ring element. The one or more boundary elements are intended for, after manufacturing the stator, forming the outer boundary of the stator disk. One boundary element means that the outer boundary of the stator disk is formed by one part that is produced and positioned as one unity. More boundary elements means that several individual parts are produced and positioned, wherein after positioning they together form the outer boundary of the stator disk. Also, at least one of the boundary elements is a cooling element adapted for conducting heat. A cooling element is intended for discharging heat from the generator. For instance, there is only one boundary element, and it is provided with internally or externally oriented cooling fins. Or, there for instance are several boundary elements of which at least a part is provided with internally or externally oriented cooling fins. Providing one or more cooling elements contributes to an efficient cooling of the stator, and therefor to a durable generator that performs well with a high yield. Moreover, as a cooling element/cooling elements also serve as boundary element to form the outer circumference, the number of required parts is kept limited. This contributes to an efficient production and assembling of the generator.

After positioning, the ring element forms the inner circumference of the stator disk, whereas the one or more boundary elements together form the outer circumference. The individual stator elements are positioned between this inner circumference and outer circumference. For instance, first all one or more boundary elements are positioned and subsequently all individual stator elements are. Or individual boundary elements and individual stator elements are for instance alternately positioned. The sequence of positioning can for instance be determined by the simplicity of assembling at given specific dimensions of the stator and its parts. This contributes to an efficient production method.

A final step in the method according to the invention comprises filling the empty space between the outer circumference formed by the one or more boundary elements, the stator elements and the ring element with an electrically insulating filling material. The filling material for instance is polyester resin, optionally supplemented by glass fibers. After the filling material has cured, a stator disk is obtained having the ring element for inner circumference, the one or more boundary elements for outer circumference, and the stator elements anchored in the filling material. The filling material, for instance an artificial resin such as polyester, epoxy, . . . , optionally glass fiber-reinforced, is lightweight and strong, which contributes to a lightweight yet firm stator. Pouring on filling material also ensures a firm anchoring of the stator elements, without extra attachment parts being required. This contributes to a robust solution that can be made in an efficient manner. To conclude with, choosing the height of the ring element, measured along the axis of rotation, and the height of the one or more boundary elements permits determining the thickness of the manufactured stator disk, measured along the axis of rotation. By according to the method positioning the ring element, the one or more boundary elements and the stator elements on support surfaces perpendicular to the axis of rotation, a stator disk is obtained with a surface perpendicular to the axis of rotation. That way a narrow air gap can be guaranteed when mounting rotor and stator. The air gap remains visible then, so that it can easily be readjusted as well.

Optionally, positioning the one or more boundary elements and the individual stator elements takes place by means of one or more position jigs. A position jig or lay-out jig is for instance made through 3D-printing, which is an inexpensive technique. By laying the jig on the surface during production of the stator, the stator elements, ring element and boundary element(s) can be accurately positioned. A jig can be placed on top of the elements as well before pouring on the filling material. As this regards inexpensive jigs, the jigs can be integrally poured on, that means without retrieving them. This contributes to the simplicity of the production. This is also a less complicated method than when recesses need to be made in a table in order to permit accurate positioning. Especially for small series to be produced, the use of position jigs is a cheaper solution. Furthermore, in this way the position jig that is integrally poured on, will contribute to realizing a flat side of the stator disk, perpendicular to the axis of rotation. This contributes to guaranteeing a narrow air gap between stator and rotor.

Optionally, the support surfaces on which the individual stator elements are positioned are in one plane. Also optionally, the dimension measured along the axis of rotation is equal for each of the individual stator elements. This means that through the method, a stator disk is obtained in which all individual stator elements are in the same plane and all have the same height as well, measured perpendicular to said plane. After mounting stator and rotor, this permits the realization of a constant, short distance between the respective stator elements and the corresponding rotor magnets. This contributes to a high efficiency of the generator.

Optionally, the support surfaces on which the ring element and the boundary elements are positioned are moreover situated in the same plane as the support surfaces on which the individual stator elements are positioned. Moreover, the dimension measured along the axis of rotation then is the same for the ring element, the one or more boundary elements and the stator elements. This means that through the method, a stator disk is obtained in which the ring element, the one or more boundary elements, and all individual stator elements are in the same plane, perpendicular to the axis of rotation. Considering the ring element determines the thickness of the stator element, measured along the axis of rotation, this means that the stator elements are properly anchored in the filling material, and at the same time a constant narrow air gap can be guaranteed. This contributes to the efficiency and robustness of the solution.

Optionally, the one or more boundary elements are multiple individual boundary elements. This means that the outer circumference of the stator disk is formed by individual boundary elements that are linked to each other. The individual boundary elements are each individually produced. Optionally, the individual boundary elements are attached to each other to form the outer circumference. This may take place prior to positioning or during positioning. Typically, the production of individual boundary elements may take place more cheaply, for instance by means of a standard extrusion process, than would be the case if one boundary element of large dimensions has to be made. This contributes to an efficient production method.

Optionally, the individual boundary elements are all individual cooling elements, which are adapted for conducting heat. This means that after positioning, the entire outer circumference is formed by cooling elements that are linked together. In that way, the cooling elements guarantee both the discharge of heat and the formation of the boundary at the outer circumference. Sufficient cooling of the machine is thus ensured and simultaneously no extra elements are required for forming the boundary. This contributes to an efficient solution that is easy to manufacture.

Optionally, the ring element is the outer ring of a radial bearing. Typically, the stator disk is mounted with bearings on a shaft. By using the outer ring of the radial bearing as ring element, no extra part needs to be used to form the inner circumference of the stator disk. This permits making the generator with fewer parts than would be the case if after producing the stator, another bearing still needs to be mounted. This contributes to an efficient production, and also to limiting the generator weight. Moreover, pouring on filling material ensures a firm anchoring of the bearing on the stator disk, and no extra connection is needed for that purpose. This contributes to a robust solution.

Also optionally, the dimension measured along the axis of rotation is larger for the inner ring than it is for the outer ring of the bearing. In other words: measured along the axis of rotation, the inner ring of the bearing has a larger height than the outer ring. As a result, rotor disks can easily be mounted onto the inner ring, on either side of the stator disk. The wanted air gap between stator and rotor is then automatically obtained. The (higher) inner ring of the bearing can be manufactured as one unity, or may consist of several rings, for instance a bearing ring having an annular part on it.

Also optionally, one of the support surfaces is a disk adapted for receiving the inner ring of the radial bearing, and manufacturing the stator comprises the following step: positioning the radial bearing with the inner ring on the disk and with the outer ring around the inner ring. Use is for instance made of a flat table in which a circular recess is provided. During production of the stator, the higher inner ring of the bearing can be placed in the recess, whereas the outer ring of the bearing is placed on the surface of the table. After manufacturing the stator, the bearing outer ring is then situated in one plane with the stator elements, whereas the higher inner ring ensures the distance to the rotor disk. That way, it is already ensured during the stator production that the narrow air gap is guaranteed and can easily be set or readjusted when mounting rotors and stators.

Optionally, a cooling element comprises one or more elongated components which are positioned between two individual stator elements. For instance, a cooling element comprises a cooling fin that is oriented towards the inner circumference of the stator disk. This permits efficient discharge of heat from the stator interior, without requiring a coolant to be brought as far as the stator elements.

Also optionally, a cooling element further comprises one or more elongated components which during positioning are externally oriented relative to the outer circumference. For instance, a cooling element comprises one or more externally oriented cooling fins. This contributes to an efficient cooling of the stator, without a coolant having to be used to cool the exterior of the stator.

Optionally, the elongated components comprise slits, arranged along a direction perpendicular to the axis of rotation. The slits are for instance arranged along the height, measured along the axis of rotation, of cooling fins. Such slits prevent eddy currents from arising, which contributes to the generator achieving a high yield.

Optionally, the method for manufacturing an axial flux machine further comprises manufacturing one or more rotors. Manufacturing a rotor then comprises the following steps:
providing a surface comprising one or more flat support surfaces perpendicular to the axis of rotation;
positioning two annular elements and magnets on the support surfaces, wherein after positioning, the magnets are situated between the annular elements;
filling the empty space between the magnets and the annular elements with an electrically insulating filling material.

In other words: also for manufacturing the rotor, a surface comprising one or more flat support surfaces perpendicular to the axis of rotation is provided. The support surfaces are parts of the surface on which according to the method rotor parts, such as magnets, are placed. The surface is for instance an entirely flat table, that means the support surfaces are all in the same plane, and positioning the various rotor parts for instance takes place by means of a position jig. Or the surface for instance is a flat table in which a number of recesses have been arranged which serve as support surfaces and permit an accurate positioning of the various rotor parts. Providing flat support surfaces perpendicular to the axis of rotation, permits obtaining a rotor after manufacturing in which the annular elements and the magnets have surfaces that are perpendicular to the axis of rotation. This contributes to guaranteeing a constant air gap between stator and rotor, along the entire surface area of the rotor disk. When assembling the stator and rotor, this permits the realization of a very narrow air gap, without the risk of contact between the stator disk and rotor disk.

Manufacturing a rotor further comprises the positioning of two annular elements. Typically, the rotor is a disk having a circular recess for the shaft of the machine in its center. The rotor disk therefore has in inner circumference, namely the circumference of the circular recess, and an outer circumference. The two annular elements are intended for, during manufacturing the rotor, determining the respective inner and outer circumference of the rotor disk. The height of these ring elements, measured along the axis of rotation, will also determine the thickness of the rotor disk, measured along the axis of rotation.

Manufacturing a rotor further comprises the positioning of two magnets. Typically, it concerns permanent magnets, magnetized along the direction of the axis of rotation. Typically, the magnets are evenly distributed around the inner circumference of the rotor. In the method, by positioning the magnets on support surfaces perpendicular to the axis of rotation, a rotor is obtained after manufacturing in which the magnets have a surface perpendicular to the axis of rotation. This contributes to guaranteeing a constant (narrow) air gap between the stator and rotor.

Manufacturing a rotor further comprises filling the empty space between the magnets and the annular elements with an electrically insulating filling material. The filling material for instance is an artificial resin such as polyester, epoxy, optionally glass fiber-reinforced. After the filling material has cured, a rotor disk is obtained, bounded by both annular elements, and the magnets anchored in the filling material. The filling material is lightweight and strong, which contributes to a lightweight yet firm rotor. Pouring on filling material also ensures a firm anchoring of the magnets, which results in a more robust solution than would be the case if the magnets are glued to it. Optionally, a notch can be arranged in the magnets to reinforce the anchoring in the filling material further. To conclude with, choosing the height of the annular elements, measured along the axis of rotation, permits determining the thickness of the manufactured rotor disk, measured along the axis of rotation. In the method, by positioning the annular elements and the magnets on support surfaces perpendicular to the axis of rotation, a rotor disk is obtained with a surface perpendicular to the axis of rotation. Even if small pits would be present in the resin surface, it is made possible in that way to guarantee a narrow air gap when mounting rotor and stator. The air gap remains visible then, so that it can easily be readjusted as well.

Optionally, manufacturing the rotor further comprises positioning ferromagnetic material between the annular elements. For instance, after positioning the magnets, strips of ferromagnetic material are arranged on the magnets, these strips connecting the magnets to each other. It is also possible to mount the magnets on the ferromagnetic material first, and subsequently turn this unit around and position it on the surface. By connecting the magnets to each other using ferromagnetic material, the magnetic flux can be closed in radial sense. This contributes to a proper efficiency of the generator. Furthermore, ferromagnetic material only needs to be provided at the level of the magnets, whereas the rest of the rotor disk may consist purely of filling material, for instance resin. This contributes to limiting the weight of the generator.

Optionally the ferromagnetic material is a helical ribbon. The ferromagnetic material is for instance supplied as a rolled up ribbon, and is unrolled during positioning. A helix of ferromagnetic material can then be created on the surface. This is a less complex method than if for instance rings of ferromagnetic material need to be made and positioned. As a consequence, this contributes to an efficient production method.

Optionally, the method for manufacturing an axial flux machine comprises mounting a rotor on the inner ring of the radial bearing. That way the rotor can easily be positioned, wherein a constant narrow air gap can be created and readjusted.

According to a second aspect of the invention, an axial flux machine is provided manufactured according to the method according to the first aspect of the invention.

According to a third aspect of the invention, a wind turbine is provided comprising an axial flux machine according to the second aspect of the invention. The axial flux machine is then adapted for generating electric energy and the wind turbine further comprises:
blades adapted for converting wind power into rotational energy;
a shaft that is fixedly mounted to the base of the wind turbine, and wherein the blades are mounted with bearings on the shaft;
a cable system comprising cables which at an outer end are attached to points at the blades and which at another outer end are attached to fixing points, wherein the stator is fixedly mounted on the shaft, and wherein the rotor is fixedly connected to the fixing points.

In this wind turbine, the shaft is fixed and the stator is fixedly mounted on the shaft. The blades are mounted with bearings on the fixed shaft. Via the fixing points, the cables form a direct connection between the blades and the rotor. The rotor is therefore directly driven via the blades, not via a rotating shaft. In that way the use of a turbine housing can be avoided, which contributes to a lower weight of the assembly that has to be mounted at altitude. By distributing the fixing points evenly along the circumference, an even load is obtained, as a result of which the whole can be executed more lightweight. By working with a fixed shaft, the attachment to the base of the wind turbine also becomes less complex and requires no heavy bearing mounting. The cables also serve as tension cables, which permits the blades to be executed more lightweight, which again contributes to a lower weight of the assembly that has to be mounted at altitude.

### BRIEF DESCRIPTION OF THE DRAWINGS

FIG. 1 is a 3D-reproduction of a stator according to an embodiment of the invention.

FIG. 2 is a cross-section of a stator perpendicular to the axis of rotation according to an embodiment of the invention.

FIG. 3 is a cross-section of a stator perpendicular to the axis of rotation according to another embodiment of the invention.

FIG. 4 is a 3D-reproduction of a stator element according to an embodiment of the invention.

FIG. 5 is a cooling element according to an embodiment of the invention, shown in a 3D-reproduction and in a cross-section perpendicular to the axis of rotation.

FIG. 6 is a cooling element according to another embodiment of the invention, shown in a 3D-reproduction and in a cross-section perpendicular to the axis of rotation.

FIG. 7 is a cooling element according to another embodiment of the invention, shown in a 3D-reproduction.

FIG. 8a and FIG. 8b show a cross-section of the stator along the axis of rotation, according to an embodiment of the invention.

FIG. 9a is a block diagram of the method for manufacturing a stator according to an embodiment of the invention.

FIG. 9b is a cross-section along the axis of rotation of a flat table used in the manufacturing of a stator according to an embodiment of the invention.

FIG. 10 is a 3D-reproduction of a rotor according to an embodiment of the invention.

FIG. 11 is a cross-section of a rotor perpendicular to the axis of rotation according to an embodiment of the invention.

FIG. 12a and FIG. 12b show a cross-section of the rotor along the axis of rotation according to an embodiment of the invention.

FIG. 13a is a block diagram of the method for manufacturing a rotor according to an embodiment of the invention.

FIG. 13b is a cross-section along the axis of rotation of a flat table used in the manufacturing of a rotor according to an embodiment of the invention.

FIG. 14 is a 3D-reproduction of two rotors mounted on a stator according to an embodiment of the invention.

FIG. 15 is a cross-section along the axis of rotation of two rotors mounted on a stator according to an embodiment of the invention.

FIG. 16 is a 3D-reproduction of a wind turbine, along the front side, according to an embodiment of the invention.

FIG. 17 is front view of a wind turbine according to an embodiment of the invention.

FIG. 18 is a 3D-reproduction of a wind turbine, along the rear side, according to an embodiment of the invention.

FIG. 19 is a cross-section along the axis of rotation of a wind turbine according to an embodiment of the invention.

### DETAILED DESCRIPTION OF THE EMBODIMENTS

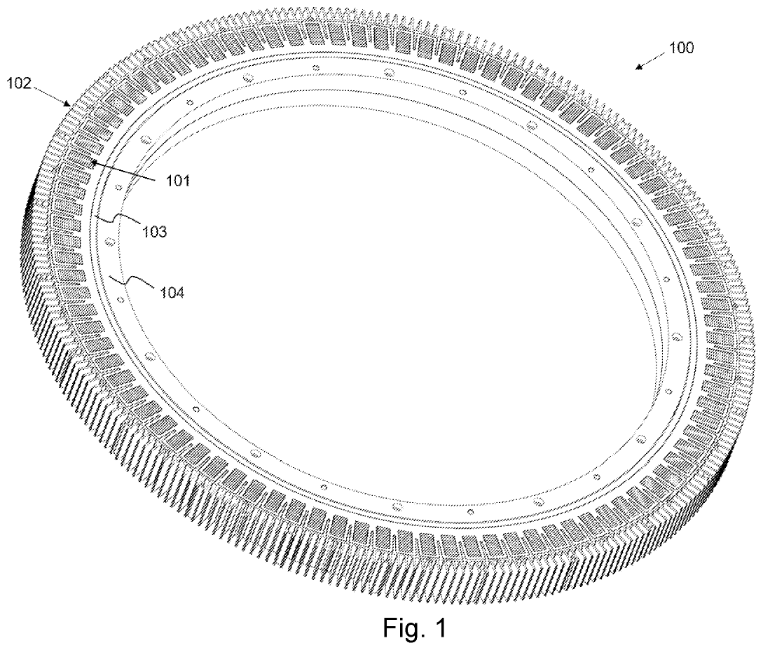

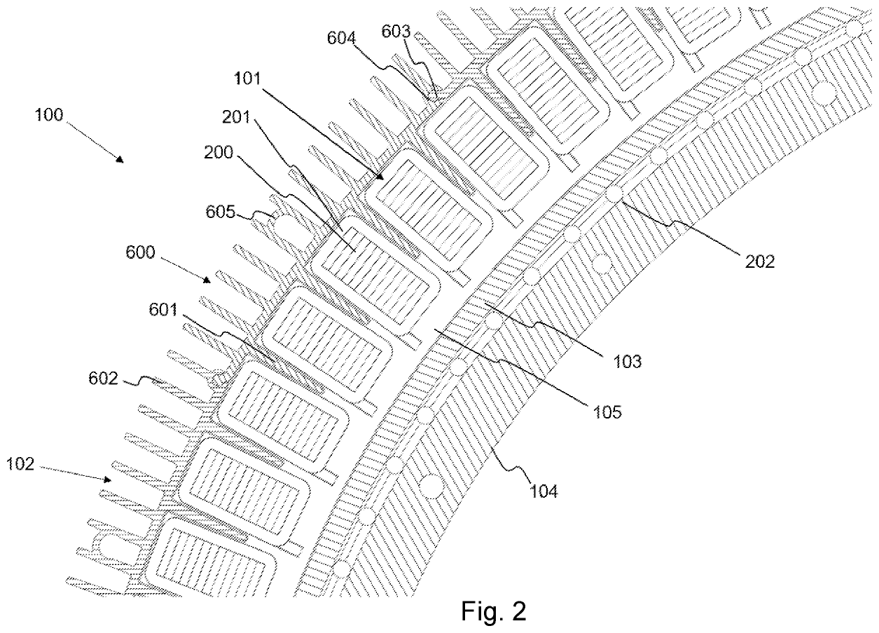

FIG. 1 shows a 3D-reproduction of a stator (100) after manufacturing according to an embodiment of the invention. FIG. 2 shows a cross-section perpendicular to the axis of rotation of this stator (100). In the embodiment shown, the stator (100) is a disk of a specific thickness, measured along the axis of rotation, in the center of which there is an aperture intended for the shaft of the machine.

FIG. 1 and FIG. 2 show a stator ring (100) wherein the inner circumference is formed by a ring element (103) and the outer circumference is formed by boundary elements (102). The stator ring (100) forms an integral unit, bounded by the ring element (103) and the boundary elements (102), the stator elements being anchored in a filling material (105). In the embodiment of FIG. 1 and FIG. 2, the ring element (103) is the outer ring of a radial bearing. The ring element (103) could also be referred to as a race element (103) or outer race (103). The radial bearing may be of any suitable type known in the state of the art, such as a ball bearing, roller bearing, slide bearing, . . . . In the embodiment of FIG. 2, the radial bearing is a ball bearing having an outer ring (103) or outer race (103), inner ring (104) or inner race (104) and balls (202). Typically, the radial bearing is tailored to this application, but if necessary the use of an available bearing of standard dimensions is also possible. Typically, the inner ring (104) of the bearing is mounted on a shaft, which during operation of the generator permits the stator (100) to be kept in a stationary position while the shaft rotates. The embodiment of FIG. 1 and FIG. 2 is advantageous as no extra part is required to form the inner circumference of the stator ring, as this function is performed by the outer ring (103) of the bearing. This limits the number of parts. However, the invention is not limited to this embodiment. In an alternative embodiment, the ring element (103) is a separate part forming the inner boundary of the stator (100), and a separate bearing is mounted on top of it. For instance, the ring element (103) is a tailor-made metal ring having a specific thickness measured along the axis of rotation. Typically, the ring element (103) has a circular inner and outer circumference, but other shapes, such as for instance a polygon, are also possible. In FIG. 1, the ring element (103) has an inner diameter of approximately 1.6 m. However, the invention is not limited to this size, embodiments of larger as well as smaller inner diameters being possible.

In FIG. 1, the outer circumference of the stator ring (100) is formed by boundary elements (102). In the embodiment of FIG. 1, there are several boundary elements (102) linked to each other, but an embodiment comprising one boundary element (102) forming the entire outer circumference is also possible. In the embodiment of FIG. 1 and FIG. 2, the distance between the inner diameter of the ring element (103) and the outer circumference of the stator ring formed by the boundary elements (102), measured along the radial direction, is approximately 10 cm. However, the invention is not limited to this size, embodiments of a larger as well as smaller size being possible.

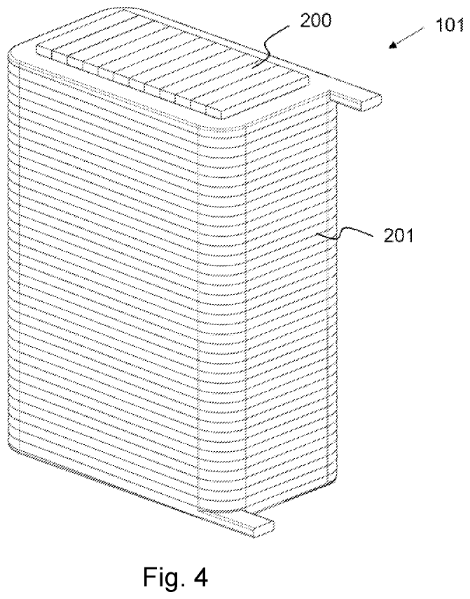

The stator elements (101) are situated between the ring element (103) and the outer circumference formed by the boundary elements (102). Typically, the stator elements (101) are evenly distributed along the circumference of the stator ring, with equal distance between two adjacent stator elements (101) measured in tangential sense. In the embodiment of FIG. 1, 92 stator elements (101) are positioned along the circumference of the stator ring (100). However, a different number of stator elements (101) higher or lower than 92, is also possible. A stator element (101) comprises a core (200) and a coil (201), as can also be seen in FIG. 4. The core (200) consists of ferromagnetic material such as Fe or Ni or FeNi alloys. Preferably, the core is constructed in a laminated fashion, comprising a plurality of layers of ferromagnetic material. In the representation of the core (200) in FIG. 4 and in the other figures, only a limited number of layers of ferromagnetic material is shown for sake of clarity of the representation. In reality, a much larger number of layers will typically be present. The ferromagnetic core (200) is for instance surrounded by a layer of electrically insulating material. At least one electrically conductive winding or coil (201), typically a copper winding, is wound around the core (200). Optionally, the coil (201) is in turn surrounded by a layer of electrically insulating material. During operation of the generator, an electric current is induced in each of the coils (201). The coils (201) are connected to each other, for instance via one or more rings. A wire or rod of electrically conductive material is for instance connected to this ring/those rings, for taking the generated electric current to the outside environment of the stator (100).

The stator elements (101) are anchored in a filling material (105) that has cured after manufacturing the stator (100). The filling material (105) preferably conducts heat but does not conduct electricity. The filling material (105) for instance is an artificial resin such as polyester, epoxy, . . . . Optionally, it is reinforced by for instance fiber glass or carbon fibers.

In FIG. 1 and FIG. 2, the outer circumference of the stator ring (101) is formed by boundary elements (102) that are linked to each other. The outer circumference has the shape of a circle or polygon. In the embodiment of FIG. 1 and FIG. 2, all boundary elements (102) are also cooling elements (600), which means that they are suitable for conducting heat. This is advantageous in obtaining a proper discharge of heat when the generator is operative, and in limiting the number of parts. However, the invention is not limited to such an embodiment, and embodiments in which the boundary elements consist of cooling elements on the one hand and elements without a cooling function on the other hand, are also possible. In such an embodiment for instance the outer circumference of the stator (100) is built up from a sequence in which a cooling element is alternated with a boundary element without a cooling function.

The boundary elements (102) functioning as cooling elements (600) are made of a non-ferromagnetic material having a proper thermal conductivity, for instance Al, an Al alloy, copper or a copper alloy. In FIG. 2, the cooling elements (600) have elongated components (601) extending between the stator elements (101). Preferably, an elongated component (601) is situated between each pair of stator elements (101). This ensures that during operation of the generator, heat is discharged from locations in the vicinity of where the heat is produced. On the one hand, the distance between an elongated component (601) and a stator element (101) is small to ensure a proper thermal contact, but on the other hand large enough to permit an easy positioning of a stator element (101) without the risk of damaging the insulating exterior layer of the stator element (101). Furthermore, the cooling elements (600) in FIG. 2 have elongated components (602) that are externally oriented relative to the outer circumference of the stator (100). They permit increasing the contact surface with the ambient air, so that during operation of the generator an improved cooling is achieved than would be the case if externally oriented elongated components (602) were absent. The advantage of the embodiment of FIG. 2, including internally and externally oriented elongated components (601, 602, respectively) is that no cooling by means of a coolant circulating in the interior or exterior of the stator (100) needs to be used. However, an embodiment in which there are no externally or no internally oriented elongated components (601, 602, respectively), and use is made of a coolant circulating in the interior or exterior of the stator (100) is also possible.

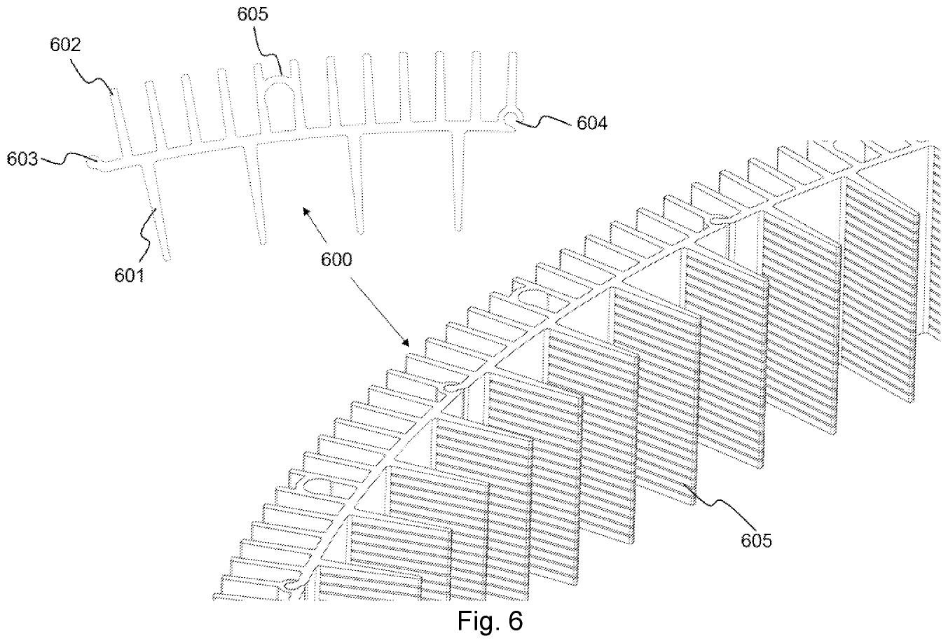

FIG. 6 shows a 3D-reproduction and a cross-section perpendicular to the axis of rotation of a cooling element (600) according to an embodiment. This is the embodiment of the cooling element (600) as can also be seen in FIG. 1 and FIG. 2. In this embodiment, a cooling element (600) has four internally oriented elongated components (601) and twelve externally oriented elongated components (602). In FIG. 2 it can be seen how three stator elements (101) have been placed between the three respective pairs of internally oriented elongated components (601). The cooling elements (600) are linked together to form the outer circumference of the stator (100). In the embodiment of FIG. 1, FIG. 2 and FIG. 6, use is then made of a snap system, permitting an outer end (603) to be snapped into an outer end (604) of an adjacent cooling element (102). A similar system can be used for connecting boundary elements (102) without a cooling function to each other, or connecting boundary elements (102) without cooling function to cooling elements (600). Other ways of connecting boundary elements (102) with or without cooling function are also possible, such as gluing, welding or a mechanical connection. To conclude with, FIG. 6 shows how a connection (605) between two externally oriented elongated components (602) permits forming fixing points, with which the stator (100) can be secured. The advantage of this is that no extra components are needed to form such fixing points.

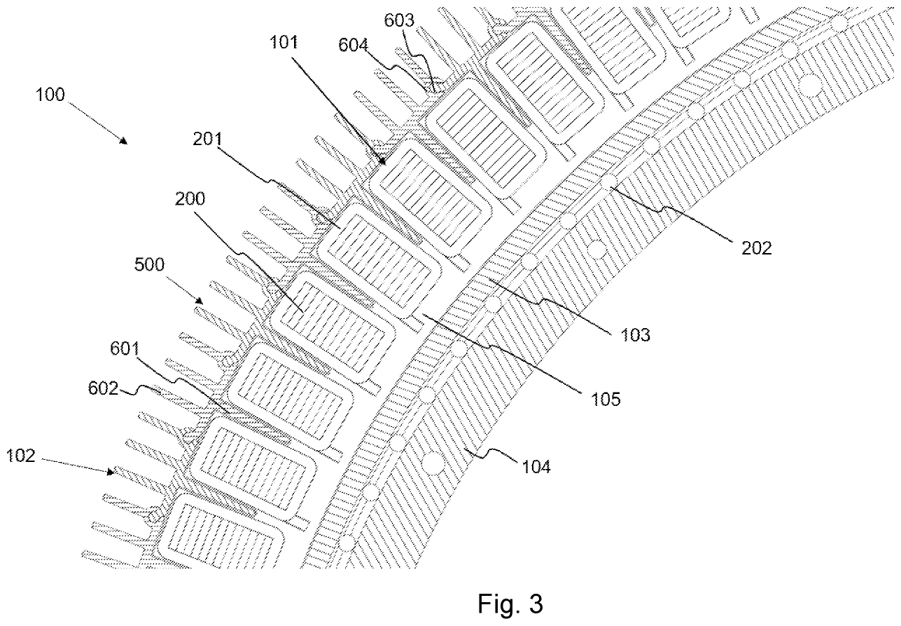

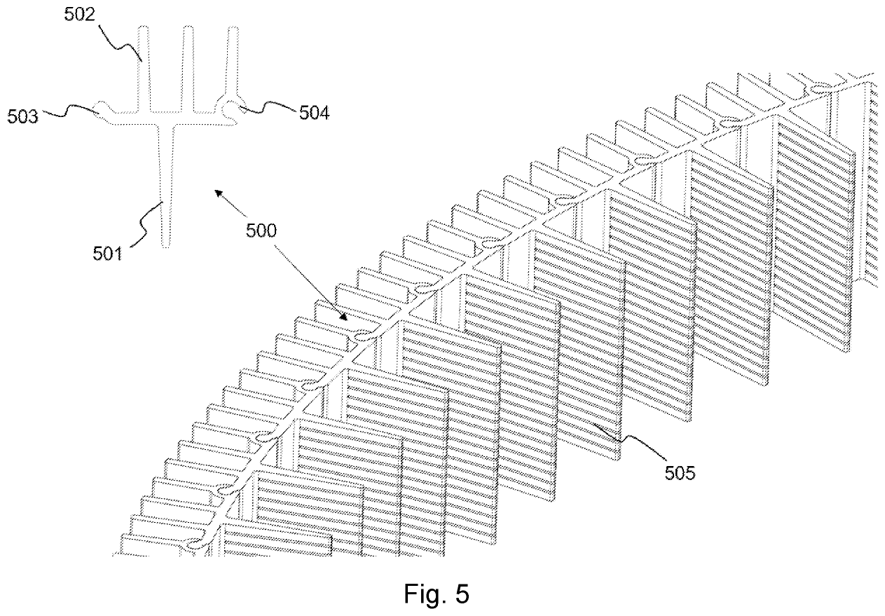

FIG. 5 shows another embodiment of a cooling element (500). In this embodiment the cooling element (500) comprises three externally oriented elongated components (502) and one internally oriented elongated component (501). FIG. 3 shows how within the stator (100) each time one stator element (101) is situated next to an internally oriented elongated component (501). In this figure, the cooling elements (500) are linked to one another by a snapping operation using the outer ends (503) and (504).

When manufacturing the stator (100), a cooling element (600) or (500) is produced as an integral part. The cross-sections shown in FIG. 6 and FIG. 5 permit producing the cooling element (102, 300) by means of a simple production technique for which standard machines are available. The production of a cooling element (500, 600) for instance takes place by means of an extrusion process, for instance Al-extrusion or by means of 3D-printing.

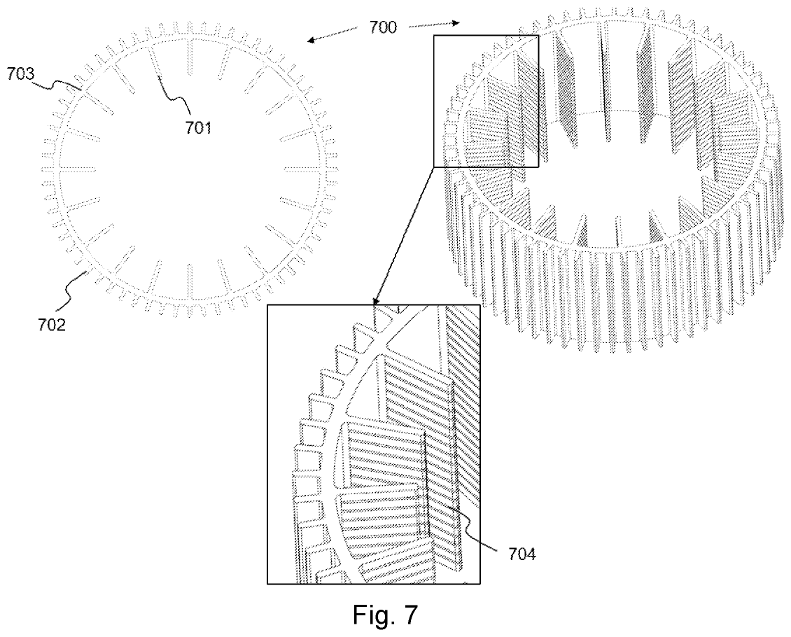

FIG. 7 shows yet another embodiment of a cooling element (700). When using a cooling element (700) within a stator (100), there is only one cooling element that also serves as single boundary element. The cooling element (700) consists of a ring (703) on which internally oriented elongated components (701) and externally oriented elongated components (702) are situated. Preferably, the ring (703) and the elongated components (701, 702) form one unity, but a mechanical anchoring of the components (701) and/or (702) on the ring (703) is also possible.

Preferably, a cooling element (500, 600, 700) is manufactured as one unity, in a heat conducting material such as Al or an Al alloy. That way, there is not a single interruption in the path that heat to be discharged needs to follow from an internally oriented elongated component (501, 601, 702) towards an externally oriented elongated component (500, 600, 701). This permits optimal conduction of heat and therefore optimal discharge of heat during operation of the generator. The cross-section perpendicular to the axis of rotation of the elongated components (501, 502, 601, 602, 701, 702) can have various shapes, such as rectangular or narrowing towards the tip. Optionally, the cross-section along the axis of rotation of an internally oriented elongated component (501, 601, 702) does not integrally consist of material, but interruptions have been made in it, for instance in the form of slits (505, 606, 704). In the embodiment in FIG. 5, FIG. 6 and FIG. 7, the slits (505, 606, 704) are made perpendicular to the axis of rotation and there are several slits (505, 606, 704) along the height, measured along the axis of rotation, of an elongated component (501, 601, 701). Other shapes and directions of interruptions made in an internally oriented elongated component (501, 601, 702) are also possible. Providing interruptions or slits (505, 606, 704) prevents eddy currents from arising which adversely affect the efficiency of the generator. The slits (505, 606, 704) are for instance made after the production of a cooling element (500, 600, 700 respectively), for instance by sawing or cutting, or are already provided during production of the cooling element (500, 600, 700) for instance by 3D-printing.

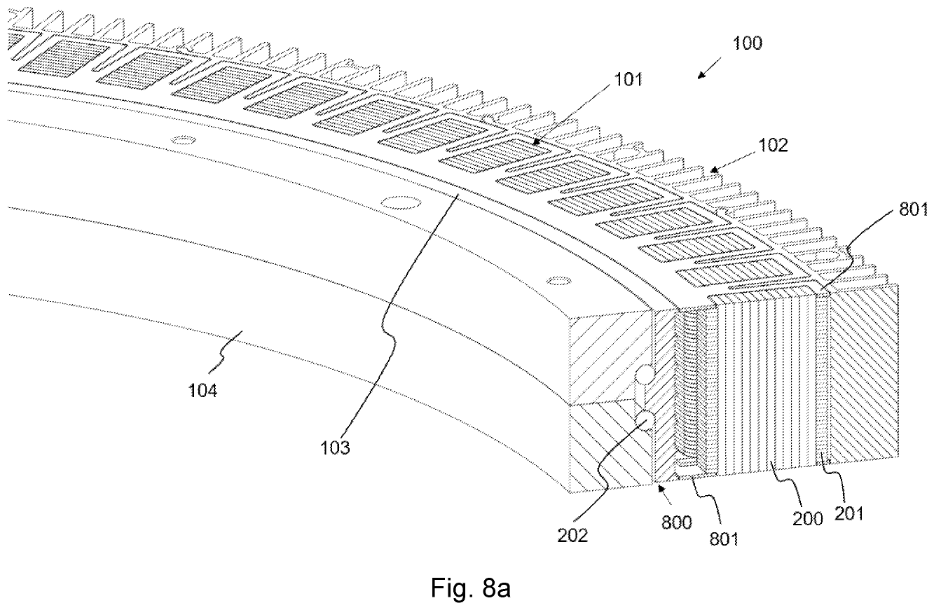

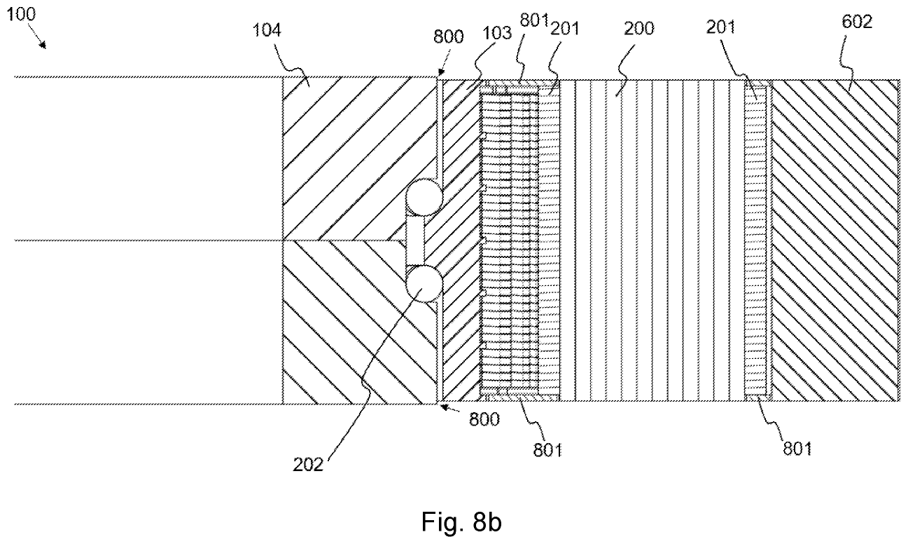

FIG. 8a and FIG. 8b show a cross-section of the stator ring (100) along the axis of rotation, according to an embodiment of the invention. It shows a position jig (801), which in the manufacturing of the stator (100) is poured on as permanent material. In the embodiment of FIG. 8a and FIG. 8b, the ring element (103), the cores (200) and the boundary elements (102) have surfaces that are perpendicular to the axis of rotation, and that are all situated perfectly in one plane. The position jig (801) is also situated in this very same plane. A perfectly flat stator wall perpendicular to the axis of rotation is then obtained. Small pits, if any, arising in the filling material (105) may be permissible as long as the stator elements (101) are properly anchored in the filling material (105). In FIG. 8a and FIG. 8b, the ring element (103) is the outer ring of a radial bearing. FIG. 8b also shows that the height, measured along the axis of rotation, of the inner ring (104) of this bearing is slightly larger than the height, measured along the axis of rotation, of the outer ring (103). Once a rotor (1000) has been mounted on the inner ring (104), this difference in height will form the air gap (800) between the cores (200) and the magnets (1003). The advantage thereof is that a very narrow air gap (800) can be realized, the thickness of which, measured along the axis of rotation, can be guaranteed at any location. In an alternative embodiment, both bearing rings (103, 104) are equally high, and the difference in height, measured along the axis of rotation, is obtained by mounting an extra annular element on the inner ring of the bearing. In the embodiment of FIG. 8b, the thickness, measured along the axis of rotation, of the air gap (800) is approximately 1 mm, and the thickness, measured along the axis of rotation, of the stator ring (100) is approximately 14 cm. Larger or smaller thicknesses are possible, however. Optionally, the optimal thickness of the air gap (800) can be defined in function of the degree of deflection of rotor (1000) and/or stator (100) which arises as a result of magnetic forces during operation of the generator. This can be determined through simulations or by experiments.

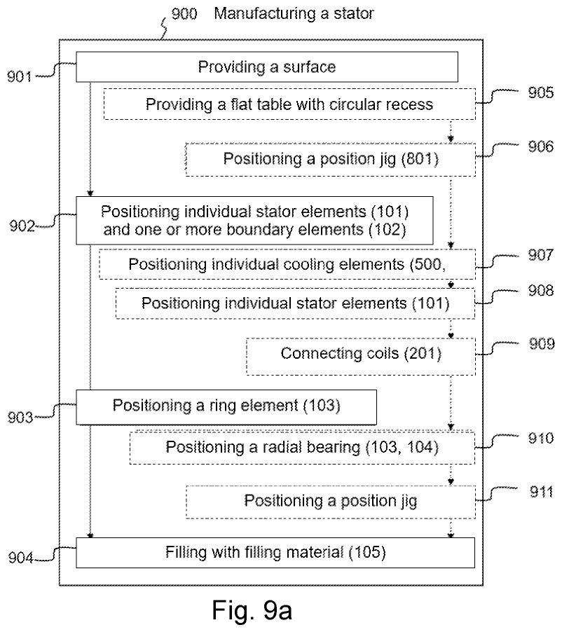

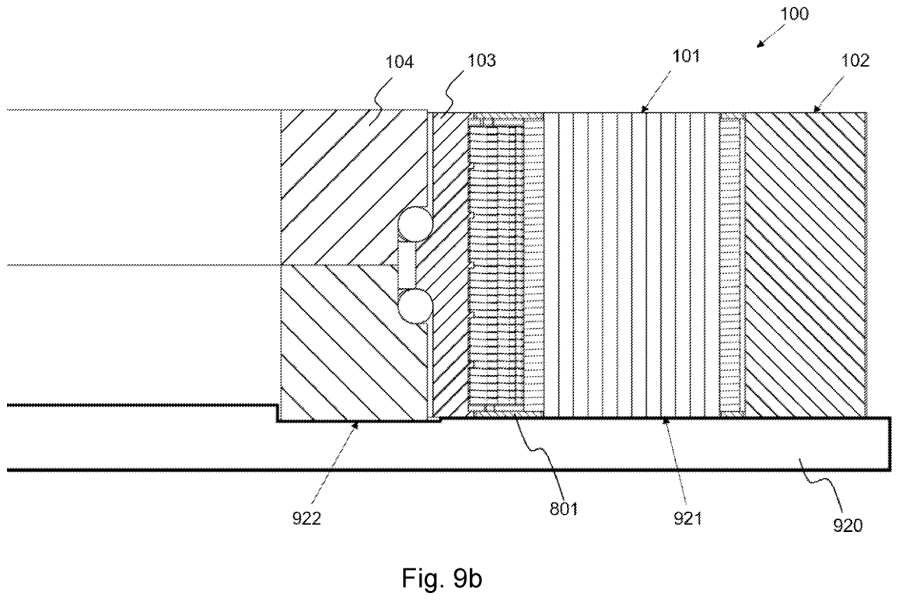

FIG. 9a shows an embodiment of the method (900) for manufacturing a stator (100) according to the invention. Steps referred to in a text box with broken lines indicate a step that is optional or specific to this embodiment. FIG. 9a also indicates a specific sequence of the steps to be carried out. However, the invention is not limited to this embodiment, and other sequences of the steps to be carried out, particularly as regards the positioning of the various elements, is possible. FIG. 9b shows a cross-section along the axis of rotation of a table (920) used in the manufacturing of the stator (100). FIG. 9b also shows the stator (100) after the steps referred to in FIG. 9a have been carried out.

In the embodiment of FIG. 9a, a surface is provided in a first step (901), which surface comprises one or more flat support surfaces (921, 922) perpendicular to the axis of rotation. Optionally, this is providing (905) a perfectly flat table (920), consisting of one flat surface (921) in which a circular recess (922) is provided. Referring to the embodiment of FIG. 8b, in which the ring element (103) is the outer ring of a radial bearing, and the inner ring (104) has a larger height, measured along the axis of rotation, the circular recess (922) is intended for receiving the inner ring (104) of the bearing. The perfectly flat surface (921) is intended for receiving the stator elements (101), the boundary elements (102) and the ring element (103) for positioning. In another embodiment the flat table comprises several shallow recesses serving as support surfaces, intended for receiving the stator elements (101 and/or ring element (103) and/or boundary elements (102). The surface (921) has to be treated such as not to bond to the filling material (105) with which everything will be poured on. Optionally, a piece of paper or foil can be used for that purpose.

In the embodiment of FIG. 9a, in which use is made of an entirely flat table having a circular recess, first one or several position jigs (801) are positioned on the perfectly even surface, as indicated in step (906). A jig for instance consists of several pieces that snap into each other and optionally are glued together using a thin soluble glue, or it can be made as one unity. The position jig (801) comprises recesses corresponding to the shape of the elements to be positioned. A position jig (801) is for instance made from plastic through 3D-printing, or manufactured by means of a technique such as cutting, or punching, etc. The jig (801) will be poured on as permanent material. A position jig (801) serves to indicate where the elements have to be positioned, and to keep these elements in their right places more properly. The recesses in the position jig (801) may optionally be provided with a small legs and small bumps, so that when an element does not have the exact dimensions, the recesses yield slightly flexibly.

In FIG. 9a, the individual stator elements (101) and the one or more boundary elements (102) are positioned in a next step (902). Referring to the embodiment of FIG. 2 or FIG. 3, this step relates to the positioning (907) of individual cooling elements (500, 600) on the one hand and the positioning (908) of individual stator elements (101) on the other hand. For instance, all individual cooling elements (500, 600) are placed first, the position being accurately determined by the position jig (801). The individual cooling elements (500, 600) can be linked together beforehand, using the outer ends (503, 504, and 603, 604, respectively) or this can be done during positioning. In the latter case, for instance a cooling element (500, 600) is placed and snapped to an already positioned cooling element (500, 600). Subsequently, all individual stator elements (101) are positioned, once again using the position jig (801). In an alternative embodiment, the individual cooling elements (500, 600) are placed alternating with the individual stator elements (101), which could optionally permit a less complex positioning of the stator elements (101) between the internally oriented elongated components (501, 601). After positioning the stator elements (101), the coils (201) are connected in step (909), for instance by soldering them to one or more rings, and connecting a conductor thereto which is taken to the outside via recesses in the cooling elements (500, 600). In the embodiment of FIG. 9a, this takes place even before the rings of the radial bearing (103, 104) are positioned. The advantage thereof is that the stator elements (101) are properly accessible.

In the embodiment of FIG. 9a, the radial bearing, including inner ring (104) and outer ring (103), is subsequently positioned in steps (903) and (910). For instance, the inner ring (104) is first placed in the circular recess in the table, and subsequently the outer ring is positioned on the flat table.

In the embodiment of FIG. 9a, in step (911) a jig is also placed on top of the positioned elements to keep everything precisely in its place, but this not a necessity. Optionally, a lid that does not bond to the resin can be placed on top of it, to keep the positioned elements in their correct places. Subsequently, the empty spaces between the ring element (103), the boundary elements (102) and the stator elements (101) are filled with a filling material (105) in step (904). The filling material (105) preferably conducts heat but does not conduct electricity. The filling material (105) for instance is an artificial resin such as polyester, epoxy, . . . . Optionally prior to filling, for instance glass fibers or carbon fibers can be placed in the empty spaces between the stator elements (101). Subsequently the unit is poured on or a vacuum is applied thereon using filling material (105). Preferably, no air bubbles are left in the filling material (105). After the filling material (105) has cured, a flat stator disk (100) is obtained, wherein the filling material (105) ensures bonding to the outer bearing ring (103) and wherein the stator elements (101) are firmly anchored in the filling material (105). This flat stator disk (100) can be seen in FIG. 9b.

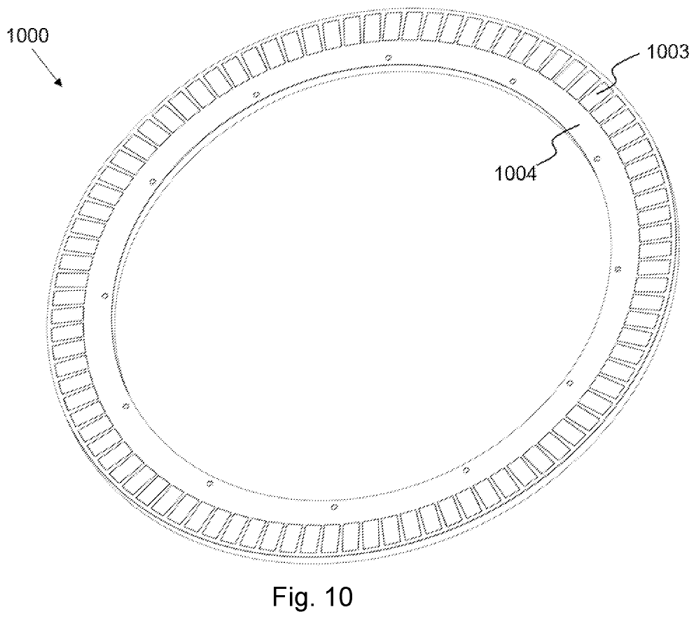

FIG. 10 shows a 3D-reproduction of a rotor (1000) according to an embodiment of the invention. Typically, the rotor (1000) is a disk of a specific thickness, measured along the axis of rotation, in the center of which there is an aperture intended for the shaft of the machine. The rotor ring (1000) forms an integral part, wherein the magnets (1003) are anchored in a filling material (1004). Typically, the inner circumference and the outer circumference of the rotor ring (1000) have a circular cross-section perpendicular to the axis of rotation, but other shapes, such as for instance a polygon, are also possible.

Typically, the magnets (1003) are evenly distributed along the circumference of the rotor ring, with equal distance between two adjacent magnets (1003) measured in tangential sense. In the embodiment of FIG. 10, 92 magnets (1003) are positioned along the circumference of the rotor ring (1000). However, a different number of magnets (1003) higher or lower than 92, is also possible. The magnets (1003) typically are permanent magnets, but another type, such as for instance electromagnets, is also possible. In the embodiment of FIG. 10, a magnet (1003) in radial sense consists of one unit. However it is also possible that a magnet (1003) in radial sense consists of several separate units. The cross-section of a magnet (1003) perpendicular to the axis or rotation may have several shapes, such as rectangular, or narrowing towards an outer end.

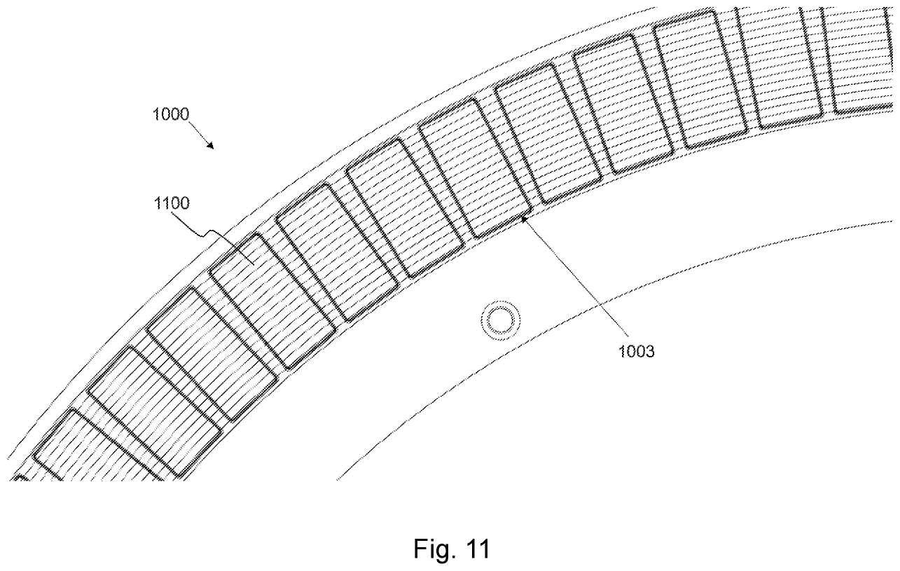

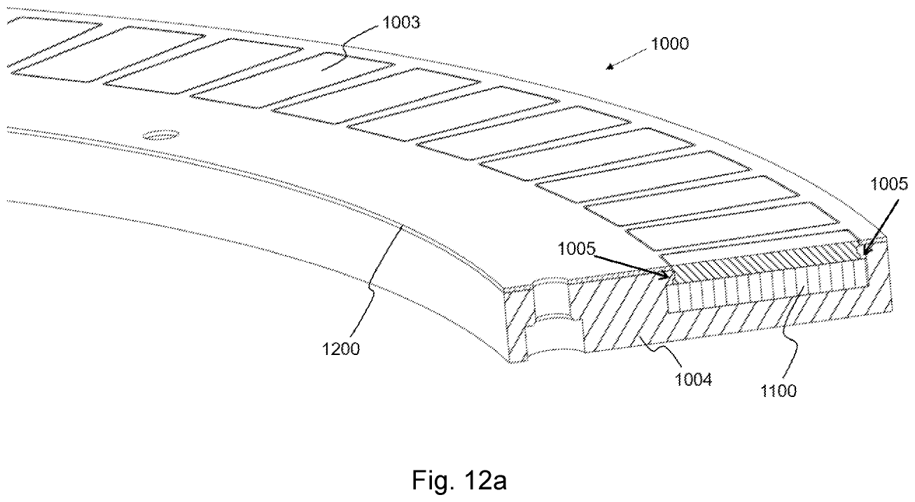

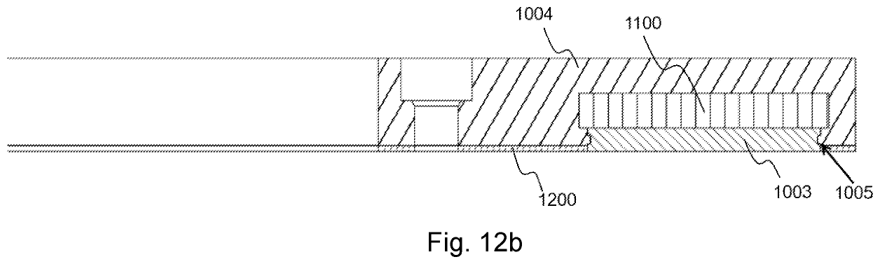

FIG. 12a and FIG. 12b show a cross-section along the axis of rotation of a rotor (1000) according to an embodiment. It shows a position jig (1200), which in the manufacturing of the rotor (1000) is poured on as permanent material. FIG. 11 shows a cross-section perpendicular to the axis of rotation of a rotor (1000) according to an embodiment. In the embodiment of FIG. 11, FIG. 12a and FIG. 12b, the rotor (1000) comprises ferromagnetic material (1100). Any material that can easily be magnetically polarized can be used as ferromagnetic material (1100), such as transformer steel, iron-nickel alloys, alloys of iron and silicon, etc. FIG. 12a and FIG. 12b show that a magnet (1003) does not continue along the full thickness, measured along the axis of rotation, of the rotor ring, but that a part of this thickness is taken up by ferromagnetic material (1100). In the embodiment of FIG. 11, FIG. 12a and FIG. 12b, the ferromagnetic material (1100) has the shape of a helical ribbon, wherein the ribbon makes several revolutions along the circumference of the rotor ring (1000), and the various circular strips contact each other and optionally are glued together. The advantage thereof is that in the manufacturing of the rotor, the ferromagnetic material (1100) can easily be unrolled like a continuous ribbon. Other embodiments are possible however, wherein for instance use is made of concentric circles of ferromagnetic material that abut each other, or of one single broader strip of ferromagnetic material. Preferably, in the radial sense the location where the ferromagnetic material (1100) is situated, is determined by the dimensions of the magnets (1003) in radial sense. The advantage thereof is that the ferromagnetic material (1100) contributes to closing the magnetic flux lines, but for the remaining part the rotor (1000) may consist of a more lightweight material.

The magnets (1003) and the ferromagnetic material (1100) are anchored in an electrically insulating filling material (1004), for instance an artificial resin such as polyester, epoxy, . . . , which has cured after manufacturing the rotor (1000). Optionally, it has been reinforced by for instance fiber glass or carbon fibers. Optionally, the magnets (1003) have a longitudinal notch (1005) to enhance the bonding in the filling material (1004).

In FIG. 12b it can be seen that the rotor ring (1000) has a surface, which includes the magnets (1003) and the position jig (1200) in there, which is perpendicular to the axis of rotation, and is completely flat. This makes it possible to realize a constant narrow air gap (800) after mounting stator (100) and rotor (1000). The thickness, measured along the axis of rotation, of the rotor disk (1000) on the one hand is determined by the height, measured along the axis of rotation, of the magnets (1003) and the ferromagnetic material (1100), and on the other hand by the required rigidity and strength of the rotor (1000). The required strength and rigidity of the rotor (1000) is determined by the magnitude of the forces arising during the operation of the generator, which in turn depends on the capacity level of the generator. In the embodiment of FIG. 12b, the thickness, measured along the axis of rotation, of the rotor ring (1000) is approximately 5 cm. However, embodiments having another thickness, larger or smaller than 5 cm, are also possible.

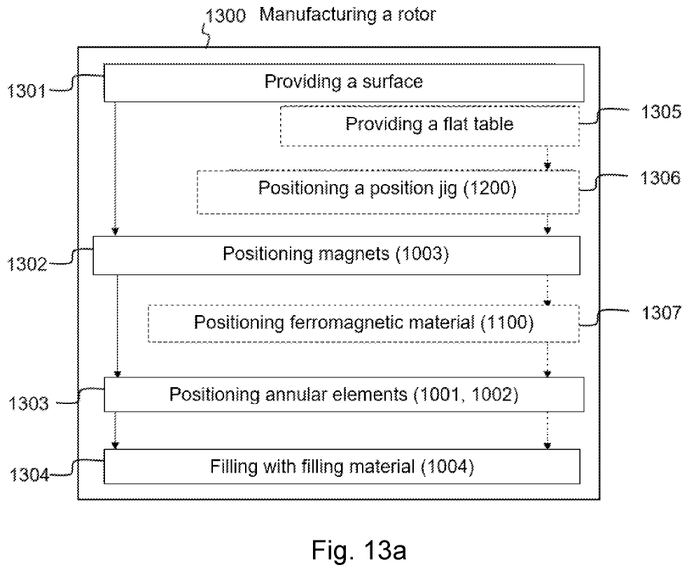

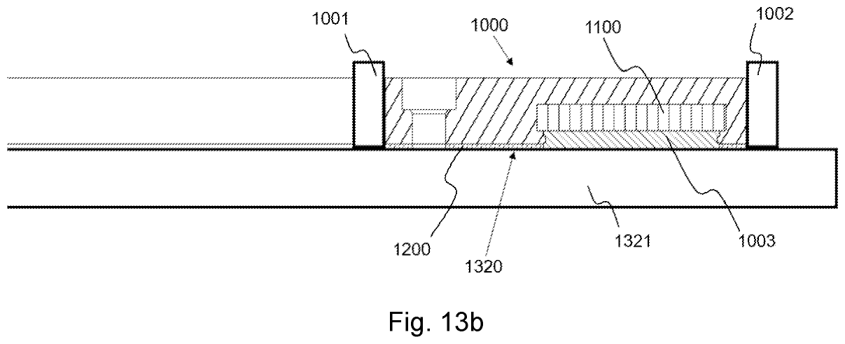

FIG. 13a shows the method (1300) for manufacturing a rotor (1000) according to an embodiment of the invention. Steps referred to in a text box with broken lines indicate a step that is optional or specific to this embodiment. FIG. 13a also indicates a specific sequence of the steps to be carried out. However, the invention is not limited to this embodiment, and other sequences of the steps to be carried out, particularly as regards the positioning of the various elements, is possible. FIG. 13b shows the cross-section along the axis of rotation of a table (1321) and two ring elements (1001, 1002) which are used in the manufacturing of the rotor (1000). FIG. 13b also shows the rotor (1000) after the steps referred to in FIG. 13a have been carried out.

In the embodiment of FIG. 13a, a surface is provided in a first step (1301), which surface comprises one or more flat support surfaces (1320) perpendicular to the axis of rotation. In the embodiment of FIG. 13a, this is providing (1305) a fully flat, perfectly even table (1321). In another possible embodiment, the flat table comprises several shallow recesses, intended for receiving the magnets (1003). Optionally, the surface (1320) is made slightly magnetic or sticky by an easily soluble adhesive. Optionally, a film or paper is used to prevent that the surface (1320) does not bond to the filling material (1004) with which everything will be poured on.

In the embodiment of FIG. 13a, first one or more position jigs (1200) are positioned on the completely even surface (1320) in step (1306). A jig for instance consists of several pieces that snap into each other and optionally are glued together using a thin soluble glue, or it can be formed as one unity. The position jig (1200) comprises recesses corresponding to the shape of the elements to be positioned. A position jig (1200) is for instance made from plastic through 3D-printing, or manufactured by means of a technique such as cutting, or punching, etc. The jig (1200) will be poured on as permanent material. A position jig (1200) serves to indicate where the elements have to be positioned, and to keep these elements in their right places more properly.

In the embodiment of FIG. 13a, the magnets (1003) are positioned in a next step (1302) by means of the position jig(s) (1200). Subsequently, in step (1307), the ferromagnetic material (1100) is arranged, for instance in the form of a helix of ferromagnetic ribbon. It is also possible to first mount, for instance glue, the magnets (1003) by means of a jig to a helix of ferromagnetic material (1100) and subsequently turn this unit around and position it on the even table.

In the embodiment of FIG. 13a, in a next step (1303), two annular elements (1001, 1002, respectively) are positioned for the inner circumference and for the outer circumference, respectively. The position jig can then be made use of The height, measured along the axis of rotation, of the annular elements (1001, 1002) determines the thickness, measured along the axis of rotation, of the rotor (1000). The annular elements (1001, 1002) are removed again once the filling material (1004) has cured.

In the embodiment of FIG. 13a, in a last step (1304), the empty spaces between the first annular element (1001), the magnets (1003) and the second annular element (1002) is filled with a filling material (1004). The filling material (1004) for instance is an artificial resin such as polyester, epoxy, . . . . Optionally prior to filling, for instance glass fibers or carbon fibers can be placed in the empty spaces between the magnets (1003). Subsequently the unit is poured on or a vacuum is applied thereon using filling material (1004). Once the filling material (1004) has cured, a flat rotor disk (1000) is obtained, wherein the filling material (1004) ensures bonding to the annular elements (1001, 1002), and wherein the magnets (1003) and the ferromagnetic material (1100) are firmly anchored in the filling material (1004). This flat rotor disk (1000) can be seen in FIG. 13b.

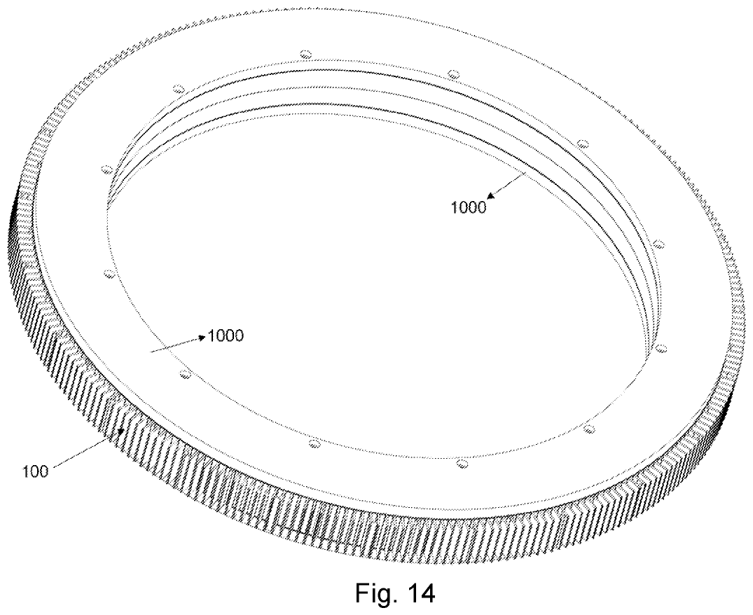

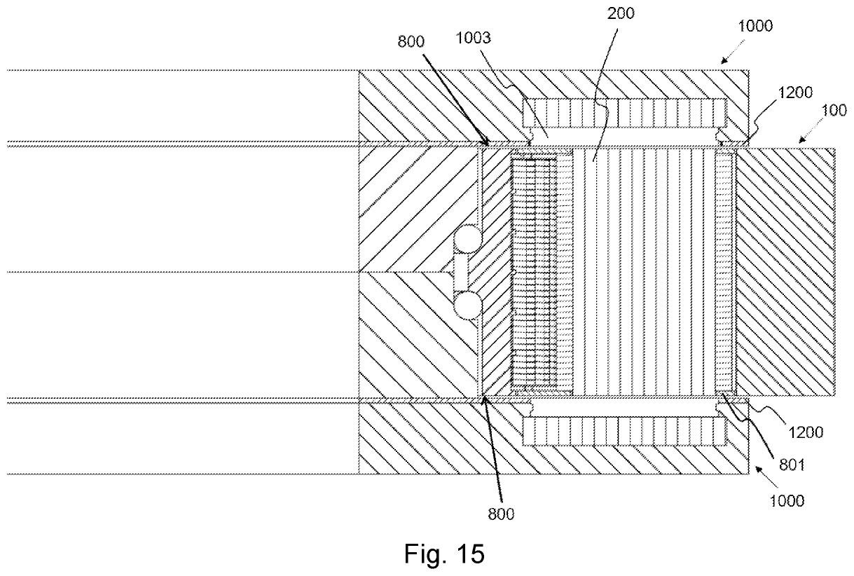

FIG. 14 and FIG. 15 show a 3D-reproduction and a cross-section along the axis of rotation of two rotors mounted on a stator according to an embodiment of the invention. A rotor (1000) is mounted on either side of a stator (100). The side of a rotor (1000) showing the surface of the magnets (1003) faces the stator (100). The radial position of the magnets (1003) on the one hand and of the stator elements (101) on the other hand is such that a magnetic flux is able to run from a magnet (1003) on the one rotor (1000), through a core (200) on the stator (100), to a magnet (1003) on the other rotor (1000). In the embodiments of FIG. 1 and FIG. 10, a stator (100) and a rotor (1000), respectively, are shown, wherein the stator (100) has 92 stator elements (101) and the rotor (1000) has 92 magnets (1003). However, the invention is not limited to a generator in which the number of stator elements (101) equals the number of magnets (1003). It is also possible, for instance, that the number of magnets (1003) exceeds the number of stator elements (101), for instance in a ratio of four over three, which is advantageous in a three-phase system.

The flat rotor ring (1000) is attached to the inner ring (104) of a radial bearing. The attachment may for instance be made by means of screws, glue or another suitable technique. In FIG. 14 and FIG. 15, the ring element (103) is the outer ring of a radial bearing, which has a height, measured along the axis of rotation, that is slightly smaller than the height of the inner ring (104) of the bearing. The difference in height between the inner ring (104) and the outer ring (103) of the bearing defines the thickness of the air gap (800) between stator (100) and rotor (1000). As a consequence, when the generator is operative, the magnets (1003) will rotate at the exact distance of the stator elements (101), on either side of the stator (100).

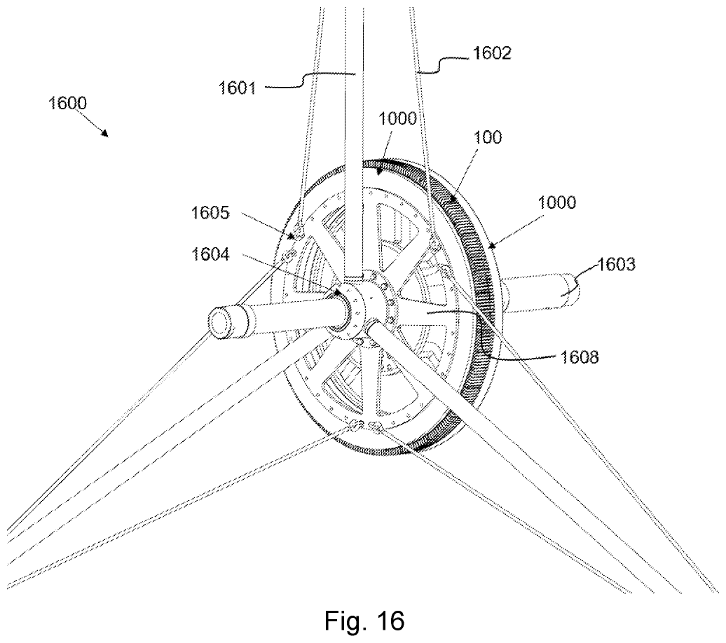

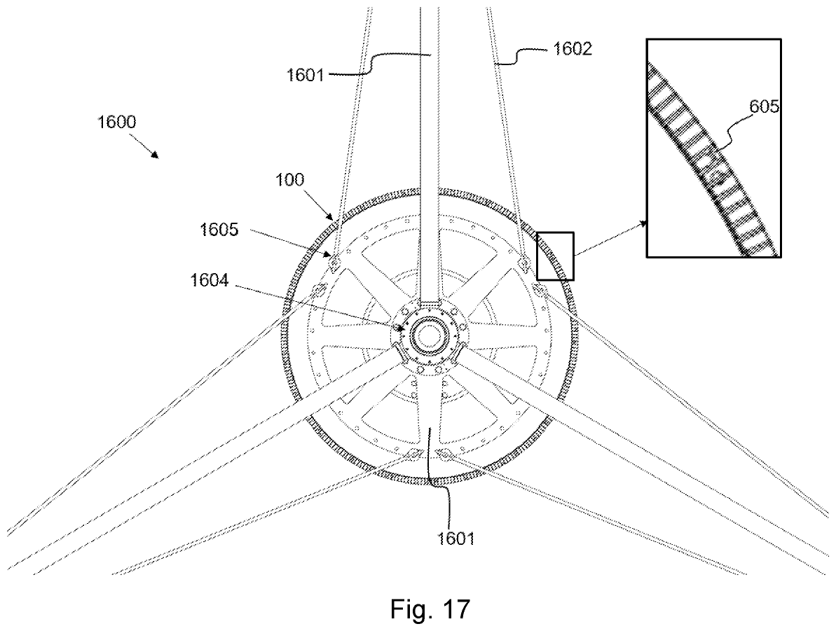

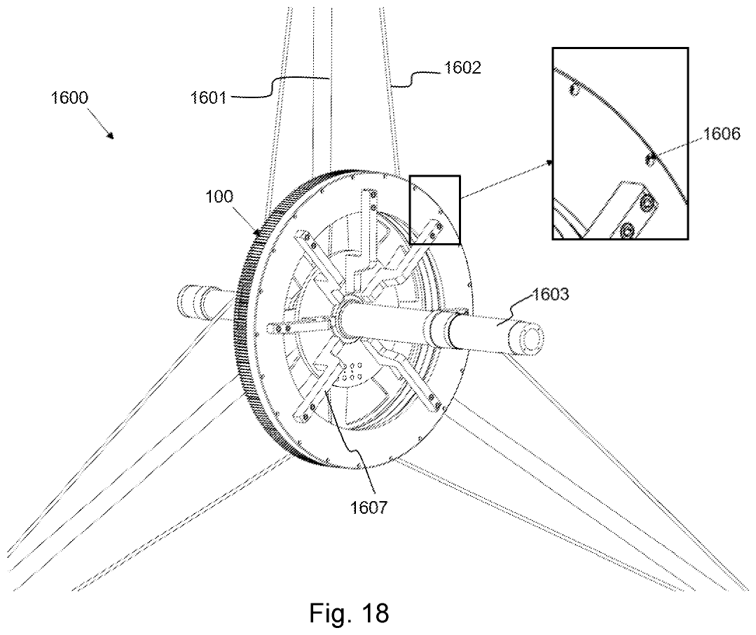

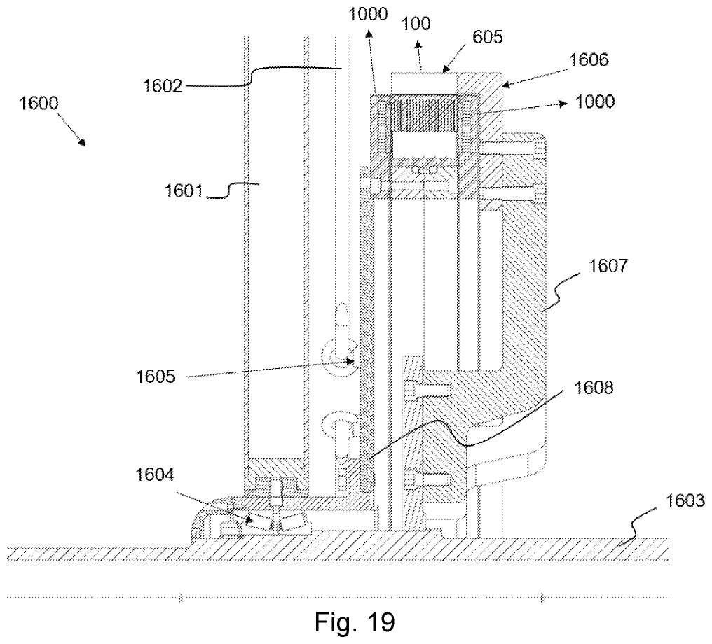

FIG. 16 and FIG. 18 show a 3D-reproduction of a wind turbine (1600), considered along the front side and rear side, respectively, according to an embodiment of the invention. FIG. 17 shows a front view of this embodiment of the wind turbine (1600), and FIG. 19 shows a cross-section along the axis of rotation. The wind turbine (1600) comprises an axial flux generator having a stator (100) and two rotors (1000). The shaft (1603) is fixedly mounted on a base. That means that the shaft (1603), arranged coaxial to the central axis of rotation of the vanes of the wind turbine, does not rotate along with the blades or vanes of the wind turbine, but constitutes a stationary bearing point for these vanes. The base is not shown in the figures, however, this base may for instance be arranged so as to be rotatable about a substantially vertical axis on top of a tower of the wind turbine, so that the substantially horizontal central axis of rotation of the blade can be positioned optimally relative to the wind direction. The blades (1601) are mounted on the fixed shaft (1603) by means of a bearing (1604). The stator (100) is fixedly mounted on the fixed shaft (1603). Use is made of the fixing points (605) which are provided in the boundary elements (600), and of bolts that are arranged through the holes (1606) so that, the stator is mounted, via the arms (1607), fixedly to the shaft (1603). It is clear that the rotors (1000) as described above are bearing mounted on the stator (100). According to the embodiment shown, cables (1602) have been mounted, wherein one outer end is attached to a blade (1601) and the other outer end is attached to a fixing point (1605). A fixing point (1605) is situated on a part that is fixedly connected to the rotor (1000) at the opposite side of the arms (1607). It is clear that each blade (1601) comprises two cables (1602) extending on either side of the longitudinal axis of the blade in a plane that is substantially transverse to the central axis of rotation of the rotor of the wind turbine including the blades, and therefore the axial flux generator as well. That way the rotor (1000) is directly driven by the blades or vanes (1601), without using a rotating shaft. In other words: at least a part of the drive torque generated by the blade of the wind turbine is directly transferred via the cables to the rotor (1000) of the axial flux generator that is situated at the side facing the vanes. This makes it possible to avoid the use of a heavy bearing mounting and a turbine casing. In other words: the drive torque exchanged between the blades (1601) and the axial flux generator via the bearing (1604) is reduced as a result. The cables (1602) also serve as tension cables, permitting the blades (1601) to be executed more lightweight. In the embodiment of FIG. 16 and FIG. 17, two fixing points (1605) per blade (1601) are provided. This ensures an evenly distributed load, so that the whole can be executed more lightweight. It is clear that according to the embodiment shown, a suitable plurality of spokes (1608) is arranged which also connect the rotor (1000) and the fixing points (1605) to the bearing (1604), and that, as at least a part of the drive torque is transferred via the cables, those spokes can then be executed more lightweight. Furthermore, it is clear that according to an alternative embodiment that is not shown, such spokes (1608) can be dispensed with, the drive torque being fully transferred to the rotor of the axial flux machine by the cables (1602).

In this context, the term “perpendicular to” a reference direction is defined as at an angle of 90° to said reference direction, with a tolerance of plus or minus 10°, preferably 5°, more preferably 3°. In this context, the term “flat surface” or “flat support surface” is defined as a perfectly even and level surface wherein any irregularities, bulges or pits in the surface have a dimension of at the most 10% of the thickness of the air gap, preferably 5%, or more preferably 3%.

Although the present invention was illustrated on the basis of specific embodiments, it will be clear to the expert that the invention is not limited to the details of the above illustrative embodiments, and that the present invention can be configured including various changes and amendments without departing from the scope of the invention. The present embodiments therefore have to be considered illustrative in all aspects and not restrictive, wherein the scope of the invention is described by the attached claims and not by the above description, and all changes that fall within the meaning and scope of the claims, will therefore be included herein. In other words: it is taken as starting point that all changes, variations or equivalents that fall within the scope of the underlying basic principles and of which the essential characteristics are claimed in this patent application, are included. Moreover, the reader of this patent application will understand that the words “comprising” or “comprises” do not preclude other elements or steps, that the word “a/an” does not preclude the plural. Any references in the claims should not be taken as a limitation of the claims in question. The terms “first”, “second”, “third”, “a”, “b”, “c” and the like, when used in the description or in the claims are used to make a difference between similar elements or steps and do not necessarily describe a sequence or chronological order. Likewise, the terms “upper side”, “lower side”, “over”, “under” and the like are used for the sake of the description and they do not necessarily refer to relative positions. It should be understood that under the right circumstances, those terms are interchangeable and that embodiments of the invention are capable of functioning according to the present invention in different sequences or orientations than those described or illustrated in the above.

1.-15. (canceled)

16. A method for manufacturing an axial flux machine adapted for generating a magnetic flux along the axis of rotation,
said method comprising the manufacturing of one or more stators,
wherein the manufacturing of said stator comprises the following steps:
providing a surface comprising one or more flat support surfaces perpendicular to said axis of rotation;
positioning one or more boundary elements, individual stator elements, and a ring element on said one or more support surfaces,
wherein at least one of said boundary elements is a cooling element adapted for conducting heat;
wherein said stator elements each comprise a ferromagnetic core and an electric winding wound around said ferromagnetic core, and
wherein after positioning, said one or more boundary elements together form an outer circumference, said individual stator elements and said ring element being situated within said outer circumference, and said individual stator elements being positioned around said ring element, and
filling the empty space between said outer circumference, said stator elements and said ring element with an electrically insulating filling material.

17. The method for manufacturing an axial flux machine according to claim 16,
wherein positioning said one or more boundary elements and said individual stator elements takes place on the basis of one or more position jigs,
wherein the one or more position jigs are part of said stator after manufacturing.

18. The method for manufacturing an axial flux machine according to claim 16,
wherein said support surfaces on which said individual stator elements are being positioned, are in one plane, and
wherein the dimension measured along said axis of rotation is the same for each of said individual stator elements.

19. The method for manufacturing an axial flux machine according to claim 18,
wherein said support surfaces on which said ring element and said one or more boundary elements are being positioned, are in the same plane as the said support surfaces on which said individual stator elements are being positioned, and
wherein the dimension measured along said axis of rotation is the same for said ring element, said one or more boundary elements and said stator elements.

20. The method for manufacturing an axial flux machine according to claim 16, wherein said one or more boundary elements are multiple individual boundary elements.

21. The method for manufacturing an axial flux machine according to claim 20, wherein said individual boundary elements are all individual cooling elements that are adapted for conducting heat.

22. The method for manufacturing an axial flux machine according to claim 16,
wherein said ring element is the outer ring of a radial bearing,
wherein one of said support surfaces is a disk adapted for receiving the inner ring of said radial bearing,
wherein the dimension measured along said axis of rotation is larger for said inner ring than it is for said outer ring, and
wherein the manufacturing of said stator further comprises the following step:
positioning said radial bearing with said inner ring on said disk and with said outer ring around said inner ring.

23. The method for manufacturing an axial flux machine according to claim 16,
wherein said cooling element comprises one or more elongated components which are positioned between two of said individual stator elements, and
wherein said cooling element comprises one or more elongated components which during positioning are externally oriented relative to said outer circumference.

24. The method for manufacturing an axial flux machine according to claim 23, wherein said elongated components comprise slits, arranged along a direction perpendicular to said axis of rotation.

25. The method for manufacturing an axial flux machine according to claim 16,
wherein said method further comprises the manufacturing of one or more rotors, and
wherein manufacturing said rotor comprises the following steps:
providing a surface comprising one or more flat support surfaces perpendicular to said axis of rotation;
positioning two annular elements and magnets on said one or more support surfaces,
wherein after positioning, said magnets are situated between said annular elements;
filling the empty space between said magnets and said annular elements with an electrically insulating filling material.

26. The method for manufacturing an axial flux machine according to claim 25, wherein manufacturing said rotor further comprises:
positioning ferromagnetic material on said one or more support surfaces,
wherein after positioning, said ferromagnetic material is situated between said annular elements.

27. The method for manufacturing an axial flux machine according to claim 26, wherein said ferromagnetic material is a helical ribbon.

28. The method for manufacturing an axial flux machine according to claim 21, comprising mounting a rotor on said inner ring of said radial bearing.

29. An axial flux machine manufactured according to the method of claim 16.

30. A wind turbine comprising an axial flux machine according to claim 27,
wherein said axial flux machine is adapted for generating electric power,
wherein said wind turbine further comprises:
blades adapted for converting wind power into rotational energy;
a shaft that is fixedly mounted to the base of said wind turbine, and
wherein said blades are mounted with bearings to said shaft;
a cable system comprising cables which at an outer end are attached to points on said blades and which at another outer end are attached to fixing points,
wherein said stator is fixedly mounted to said shaft, and
wherein said rotor is fixedly connected to said fixing points.
